(19) United States
(12) Patent Application Publication
(10) Pub. No.: US 2007/0101302 A1
(43) Pub. Date: May 3, 2007

(54) Mixed signal circuit simulator

(76) Inventor: Yoshinaga Okamoto, Kyoto (JP)

Correspondence Address: MCDERMOTT WILL & EMERY LLP, 600 13TH STREET, NW, WASHINGTON, DC, 20005-3096, US

(21) Appl. No.: 11/492,055

(22) Filed: Jul. 25, 2006

(30) Foreign Application Priority Data
Oct. 31, 2005 (JP) P2005-316595

(51) Int. Cl. G06F 17/50

(52) U.S. Cl. 716/4; 703/16

(57) ABSTRACT

The waveform created by a circuit simulator is selected. The input data 11 inputted by an inputting means are obtained for a point on the waveform or the waveform. The selected waveform and the input data 11 are analyzed by a waveform analyzing means 12 to create circuit parameter updating information 13. On the basis of the circuit parameter updating information 13, net list data are updated and the circuit simulator 5 is operated recursively. Thus, the circuit design capable of making a desired waveform can be realized.

### BACKGROUND OF THE INVENTION

1. Field of the Invention

This invention relates to a mixed signal circuit simulator, and more particularly to a mixed signal circuit simulator for analyzing the electrical characteristic of a circuit element to be fed back to design data in design of a semiconductor circuit having a large number of circuit elements.

2. Description of the Related Art

In semiconductor design in recent years, with progress of SOC (System On a Chip) of mixedly designing a digital circuit, an analog circuit, memory circuit and an RF circuit on the same chip, owing to downsizing and low voltage of the semiconductor element, the problems of a leak current, wiring parasitic capacitance, process fluctuation reliability, etc. have become increasingly important.

For a circuit designer who is required complicated and sophisticated design, simulation of the circuit designed is indispensable.

On the other hand, in a traditional design flow, the analog circuit and digital circuit have been developed in entirely different environments, respectively. They have been not collected together in a single circuit until a stage of creating a physical layout. However, such a method cannot beforehand avoid failure in a system level in the present SOC design in which the analog circuit and digital circuit have a complicate interaction, and so frequently requires considerable labor and time for modification.

In order to obviate such a state, it is necessary to execute the verification of the system level at an possible early stage of design and find the problem, thereby taking a measure for improvement. Thus, the present circuit simulator is required to have a sophisticated function for not only the purpose of “Post Layout Verification” but also capable of executing the verification of the system level in “Pre Layout Verification”. An extensive circuit simulator has been developed which can deal with SPICE (Simulation Program with Integrated Circuit Emphasis) which is the mainstream of the analog circuit, VHDL (Very High Speed Integrated Circuit Hardware Description Language) which is the mainstream of the digital circuit, and further transistor level or high frequency circuit inclusive of Verilog.

However, frequently, the analog circuit does not accurately create a waveform as compared with the digital circuit so that its automation of simulation is difficult. In a conventional analog circuit simulator also, actually, its verification and modification to a designed circuit have manually carried out in a greater part thereof. Examples of the conventional technique will be explained below.

Conventionally, there have proposed various circuit simulation systems. The arrangement (see JP-A-8-63507 (Page 7, FIG. 1)) of an example of the circuit simulation systems is shown in FIG. 19. As seen from FIG. 19, in this system, using input data E101 created by a designer and stored in file E1, an input processing means E2 creates a storage file E3 of net list data E102 and a storage file E4 of graph definition data E103. Next, a circuit simulator E5 creates a storage file E6 of analysis result data. On the basis of the file E4 and file E6, a group of data E110 are produced and stored in file E8. The file E8 is displayed on a display device E11 by a waveform displaying means E9. Further, using a graph selecting means E10, only a desired graph can be selected or rearranged.

Now referring to FIG. 20, an explanation will be given of the operation processing of the circuit simulator E5. FIG. 20 is an execution flow chart of transient analysis of a circuit simulator SPICE which is widely adopted in the computer such as EWS (Engineering Work Station) or PC (Personal Computer). In step F1, initialization is done. By this initialization, net list data are read in, thereby acquiring the voltages and currents at all the terminals of each of circuit elements in the initial state stored in the memory on the computer. Next, in step F2, “0” is substituted for a simulation time T. The simulation time T increases with progress of the simulation processing.

Upon completion of a series of processing operations, the processing shifts to the loop processing part at and after step F3. First, in step F3, the voltage value and current value at each node, stored in the memory of the computer are outputted to the file. In this case, if a specific node is designated without being limited to all the nodes, outputting is executed for only the designated node.

Next, in step F4, it is determined whether or not the present simulation time T is a simulation ending time. If it is the simulation ending time, the processing ends. If not, the processing continues and advances to step F5. In Step F5, T0 which is an initial constant value of a step value is substituted for a time step value T0. The sum (T+Td) of the step value Td and the simulation time T is set for a provisional new simulation time, thereby computing the voltage value and current value at each node.

Thereafter, in step F7, it is determined whether or not all the computation results have been converged so that the values could be obtained. If converged, in step F8, the simulation time T is updated to T+Td. Then, the processing returns to step F3 at the start of the loop. The circuit simulator repeats these series of operations until the simulating ending time is reached.

On the other hand, in step F7, if the computation results have not been converged, in step F9, the step value Td is reduced. In step F10, the reduced Td is compared with a predetermined value Tf. If the step value Td is larger, the processing returns to step F6, thereby executing the computation. However, if the step value Td is smaller than the predetermined value Tf, the simulation processing is forcibly ended.

The forcible ending of the simulation processing corresponds to the case where there is too excessive computation error to influence simulation accuracy, or the computation results are not entirely converged so that the values could not be obtained.

In the conventional technique described above, by outputting the net list data and graph definition data and inputting these data to the waveform displaying means, the waveform graph automatically processed can be displayed on the display device. However, the waveform is still confirmed, verified and reflected on a designed circuit by a designer. Their complete automation has not been realized.

However, in the present days when the circuit scale of an designed object is increased and complicated, adopting such a technique greatly increases the quantity of working by the designer and makes it difficult to effectively carry out the design of a large-scale integrated circuit.

Further, in the case of design of the analog circuit, the characteristic of the circuit elements greatly influences the entire circuit. Therefore, since the size of the circuit elements cannot be changed easily, it is difficult to realize area reduction and power savings.

Further, as compared with, the mixed signal circuit simulator is slower in the execution speed than and much inferior in the development efficiency to the digital circuit simulator.

### SUMMARY OF THE INVENTION

In view of the above circumstance, this invention has been has been accomplished. An object of this invention is to provide, in designing a circuit using a circuit simulator, a mixed signal circuit simulator which can easily modify or change the circuit through the direct operation by a designer for the waveform displayed on a display device and realize desired circuit design.

Further, in addition to the above object, another object of this invention is to provide a mixed signal circuit simulator which can design a circuit with a smaller area and low power consumption.

In addition to these objects, still another object of this invention is to provide a circuit simulator which can easily create a hardware description language and execute simulation at a higher speed.

In order to attain the above object, the mixed signal simulator according to this invention is characterized by comprising: a net list outputting means for outputting net list data from circuit information data of a circuit diagram created; a circuit simulator for outputting waveform data on the basis of the net list data and input signal data; an inputting means for inputting data with a desired value; and a waveform analyzing means for analyzing the input data created by the inputting means and the waveform data to create circuit parameter updating information.

In accordance with this configuration, without directly modifying the circuit parameter on the circuit diagram, a designer can create a circuit generating a waveform passing the vicinity of a desired input value and so can easily modify the circuit, thereby quickly creating an optimum circuit.

The mixed signal circuit simulator according to this invention is characterized in that the waveform analyzing means selects a point on the waveform selected from the waveform data so that the input data and the waveform data are analyzed to create the circuit parameter updating information.

In accordance with this configuration, the waveform analyzing means selects a point on the waveform selected from the waveform data so that the input data and the waveform data are analyzed to create the circuit parameter updating information. Therefore, without directly modifying the circuit parameter on the circuit diagram, a designer can create a circuit generate a waveform passing the vicinity of a desired input value and so easily modify the circuit, thereby quickly creating an optimum circuit.

The mixed signal circuit simulator according to this invention is characterized in that the waveform analyzing means comprises:

a waveform editing means for editing a waveform selected from the waveform data; a waveform edited result analyzing means for analyzing the waveform edited data created by the waveform editing means to create the circuit parameter updating information.

In accordance with this configuration, without directly modifying the circuit parameter on the circuit diagram, a designer can create a circuit with a desired waveform and so can modify the circuit by a more intuitive operation and easily, thereby quickly creating an optimum circuit.

The mixed signal circuit simulator according to this invention is characterized by comprising: a net list changing means for changing the net list data on the basis of the circuit parameter updating information; and a circuit information changing means for changing the circuit information data on the basis of the circuit parameter updating information.

In accordance with this configuration, without directly modifying the circuit parameter on the circuit diagram, a designer can change the net list data to create a circuit with a desired waveform, and so can modify the circuit by a more intuitive operation and easily, thereby quickly creating an optimum circuit.

The mixed signal circuit simulator according to this invention is characterized by comprising a waveform displaying means for displaying a waveform selected from the waveform data on a predetermined display device, and in that the waveform analyzing means executes analysis on the basis of the wave displayed on the waveform displaying means.

In accordance with this configuration, without directly modifying the circuit parameter on the circuit diagram, a designer can modify the circuit by a more intuitive operation and easily, thereby quickly creating an optimum circuit.

The mixed signal circuit simulator according to this invention, wherein the circuit information changing means changes the circuit information data into a fixed value relied on a design rule on the basis of the circuit parameter updating information.

In accordance with this configuration, a designer can update the circuit parameter without feeling the design rule. In addition, the set of items of circuit parameter updating information created is limited so that the repeating time of the circuit simulation can be shortened.

The mixed signal circuit simulator according to this invention is characterized in that if there are a plurality of items of circuit parameter updating information capable of making the waveform passing the vicinity of the input data created by the inputting means or the waveform edited by the waveform editing means, the circuit parameter updating information with the least circuit area or least circuit power consumption can be preferentially selected.

In accordance with this configuration, an excessive increase of the circuit area and power consumption realized by the inputting means or waveform editing means can be suppressed, thereby reducing the production cost and power consumption of the entire semiconductor integrated circuit.

The mixed signal circuit simulator according to this invention is characterized in that the waveform editing means is adapted to display the waveform under a normal condition and the waveforms under the best and worst conditions; and the inputting means or waveform editing means is accepted for a waveform selected from the waveforms, and according to the circuit parameter updating information, all the waveforms are taken as candidates for re-display or re-edition.

In accordance with this configuration, the design margin can be optimized, thereby permitting a semiconductor integrated circuit with high quality to be designed.

The mixed signal circuit simulator according to this invention is characterized in that if there is no set of items of circuit parameter updating information created by the waveform analyzing means or the waveform edited result analyzing means, and the circuit parameter can exist by changing the input signal data, an emphasized pertinent part of the input signal data is displayed on the display device.

In accordance with this configuration, if a desired waveform has not been made, the time taken to search a portion incapable of being created can be shortened.

The mixed signal circuit simulator according to this invention is characterized in that if a waveform portion inputted from the input data or edited from the waveform edited data is a part or entirety of the waveform repeated successively, a repetitive first simulation time in repetition is acquired from the waveform data, and in the circuit simulation after the net list has been changed by the net list changing means, the circuit simulation is executed from the repetitive first simulation time or its previous simulation time.

In accordance with this configuration, the circuit simulation time after value input and after waveform edition can be shortened, thereby permitting the circuit to be re-designed quickly.

The mixed signal circuit simulator according to this invention is characterized by further comprising: a net list replacing means for outputting net list replaced data from net list data using the input signal data and library data.

The mixed signal circuit simulator according to this invention is characterized in that the circuit simulator comprises: a waveform displaying means for displaying a waveform selected from the waveform data on a predetermined display device; a waveform selecting means for selecting the waveform displayed on the display device; a waveform language converting means for converting the waveform selected by the waveform selecting means into a hardware description language; and a library registering means for registering the hardware description language created by the waveform language converting means on the library data.

In accordance with this configuration, the hardware description language can be created by a simple operation and so re-simulation can be executed at a high speed.

The mixed signal circuit simulator according to this invention is characterized in that an output signal relied on the hardware description language is given as mapping of an input signal.

In accordance with this technique, the hardware description language capable of producing the output signal with high quality for an input signal can be created.

The mixed signal circuit simulator according to claim 12, wherein an output signal relied on the hardware description language is given as mapping of a simulation time.

In accordance with this technique, the hardware description language capable of producing the output signal with high quality for a simulation time can be created.

The mixed signal circuit simulator according to this invention is characterized in that the output signal relied on the hardware description language is described for both rise and fall of the input signal.

In accordance with this configuration, even when degrees of the change in the output signal in the rise and fall thereof are different, the hardware language with high quality can be created.

The mixed signal circuit simulator according to this invention is characterized in that the hardware description language under a normal condition and the hardware description languages under the best and worst conditions are registered and used through replacement by the net list replacing means.

In accordance with this configuration, the speed-up of the circuit simulation can be realized under not only the normal condition but also the best and worst condition, thereby shortening the circuit design period.

In accordance with this invention, without directly modifying the circuit parameter on the circuit diagram, a designer can create a circuit generating a waveform passing the vicinity of a desired input value and so can easily modify the circuit, thereby quickly creating an optimum circuit.

Further, the area and power consumption on the circuit created can be reduced and further the design margin can be optimized.

Further, the hardware description language can be created by a simple operation and so re-simulation can be executed at a high speed.

### BRIEF DESCRIPTION OF THE DRAWINGS

FIG. 1 is a block diagram showing the configuration of the first embodiment of this invention.

FIG. 2 is a waveform chart showing a simulation time and a Y-G voltage.

FIG. 3 is a schematic view showing a display inputted by a designer.

FIG. 4 is a block diagram showing the configuration of the second embodiment of this invention.

FIG. 5 is a constant voltage generating circuit diagram used for explaining a concrete example.

FIG. 6 is a waveform graph illustrating the manner of response in the constant voltage generating circuit.

FIG. 7 is a waveform graph illustrating the manner of response in the constant voltage generating circuit (graph illustrating a converging process by a circuit simulator).

FIG. 8 is a view showing a configuration in actual circuit design to which the configuration according to the second embodiment of this invention is added (a circuit diagram editor, design rule definition data and a device library are added to FIG. 4).

FIG. 9 is a schematic view showing the contents of the design rule definition data.

FIG. 10 is a waveform graph before and after edition of a waveform and after updating of a circuit parameter.

FIG. 11 is a block diagram showing the configuration according to the third embodiment of this invention.

FIG. 12 is a view for explaining the hierarchical structure of a circuit and net list data.

FIG. 13 is a view showing the manner of waveform selection in the third embodiment of this invention.

FIG. 14 is a view showing the data obtained by waveform selection.

FIG. 15 is a view showing the data converted from the data shown in FIG. 14.

FIG. 16 is a view showing the program codes registered on a library as mapping of an input voltage.

FIG. 17 is a view showing the program codes registered on a library as mapping of a simulation time.

FIG. 18 is a flowchart showing the process to library registering in the third embodiment of this invention.

FIG. 19 is a view showing a prior art of analog circuit simulation.

FIG. 20 is a view showing an execution flow in the operation processing in the analog circuit simulation.

### DESCRIPTION OF THE PREFERRED EMBODIMENTS

Now referring to the attached drawings, a detailed explanation will be given of various embodiments of this invention.

### Embodiment 1

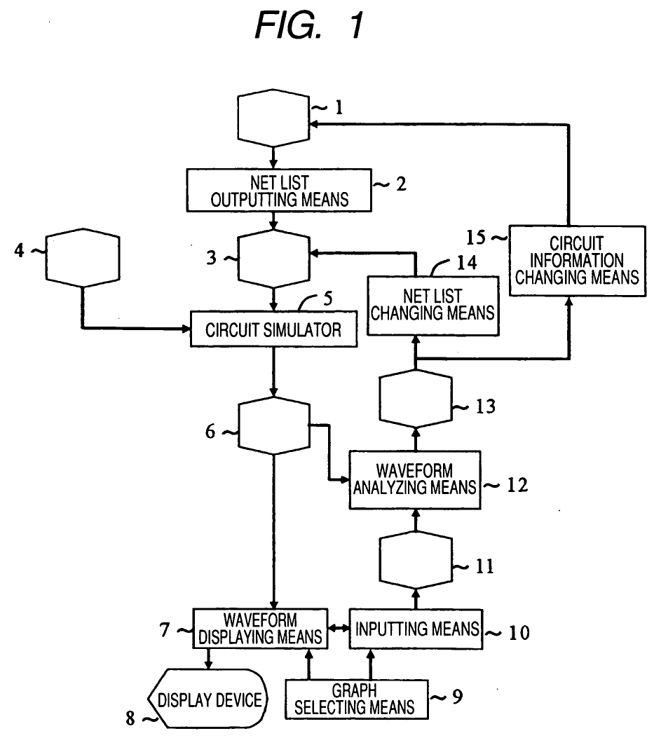

FIG. 1 is a block diagram showing the configuration of the first embodiment of this invention. This embodiment is characterized by comprising a net list outputting means for outputting net list data from circuit information data of a circuit diagram created; a circuit simulator for outputting waveform data on the basis of the net list data and input signal data; an inputting means for inputting a desired value; and a waveform analyzing means for analyzing the input data created by the inputting means and the waveform data to create circuit parameter updating information. In accordance with this configuration, without directly modifying the circuit parameter on the circuit diagram, a designer can create a circuit generating a waveform passing the vicinity of a desired input value and so can easily modify the circuit, thereby quickly creating an optimum circuit.

Specifically, the mixed signal circuit simulator according to this embodiment includes, as seen from FIG. 1, a net list outputting means 2 for outputting net list data 3 from input data of circuit information data 1 holding information of a designed circuit; a circuit simulator 5 for creating waveform data 6 on the basis of the net list data 3 and input signal data 4; a waveform displaying means 7 for graphically displaying the waveform data 6 and a waveform selected by a graph selecting means 9 on a display device; an inputting means 10 for selecting a point of the waveform displayed to the display device 8, inputting a desired value and outputting its result for input data 11; a waveform analyzing means 12 for analyzing the input data 11 and the waveform data 6 to create circuit parameter updating information 13; a net list changing means 14 for changing the net list data on the basis of the circuit parameter updating information 13; and a circuit information data changing means 15 for changing the circuit information data 1 on the basis of the circuit parameter updating information 13.

The circuit information data 1 containing the information of the circuit created by the designer are processed by the net list outputting means 2, thereby producing the net list data containing circuit element information and connection information of circuit elements. By the net list data 3 and the input signal data 4 which describe an applying voltage and an applying current necessary for circuit simulation, a simulation condition, etc., the circuit simulator 5 is operated. Thus, actual circuit simulation is done so that an integrated circuit to be analyzed is analyzed. The circuit simulation result is outputted to the waveform data 6. The waveform data 6 are inputted to the waveform displaying means 7. The waveform displaying means 7 graphs the waveform data 6, and the graph selected by the graph selecting means 9 is displayed on the display device such as a display. By means of the inputting means 10, the designer can select a point of the waveform of the graph selected and the result selected is stored in the input data. By means of the waveform analyzing means 12, the input data 11 and waveform data 6 are analyzed to create the circuit parameter updating information 13. The net list changing means 14 changes the circuit parameter component of the net list data 3 using the circuit parameter updating information 13 and further operates the circuit simulator 5. The waveform data created by this operation is analyzed for comparison with the input data inputted by the designer by the waveform analyzing means 12. If the error is within a permissible error, the circuit information data 1 are changed by the circuit information data changing means 15. However, if the error is not within the permissible error, new circuit updating information 13 different from that in the previous simulation is created and the net list data are updated. Such a series of operations are repeated. This repetition is continued until the error stays within the permissible error and the circuit parameter updating information cannot be created any longer.

The above series of operations will be explained later.

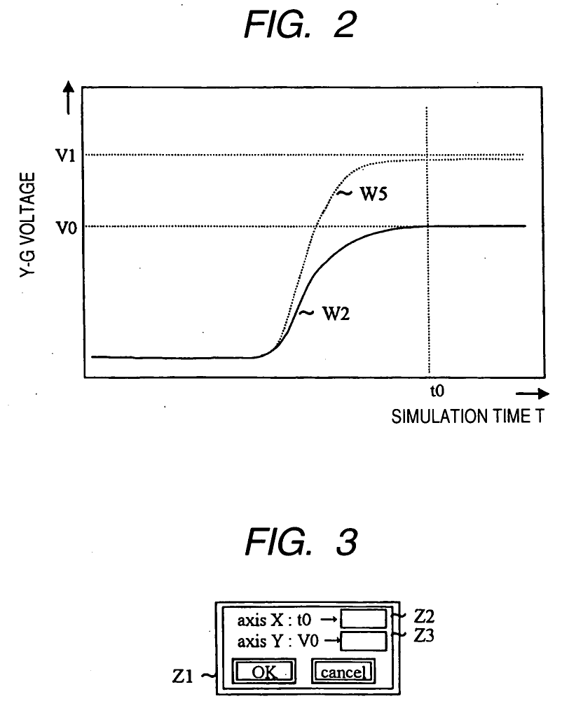

Now referring to FIG. 2, the inputting means will be explained. FIG. 2 is a waveform graph taking an X-axis of a simulation time T in a certain block and a Y-axis of an output terminal Y-G voltage. When the inputting means selects a point on the waveform in FIG. 2 using a pointing device or its alternative device, an input designating screen Z1 as shown in FIG. 3 is displayed. On this input designating screen, the values selected on the waveform in the X-axis and Y-axis are indicated as t0 and V0 (in real numbers, respectively). The values such as Z2 and Z3 in FIG. 3 are inputted for both axes, respectively It should be noted that inputting of both values is not required and the above value on the waveform is used for the value not inputted. Now, if “V1” (real number) is inputted as the value in the Y-axis, t0, V1 and the gradient of a waveform W2 at t0 are recorded on the inputted data.

As described previously, the circuit simulator carries out discrete simulation so that the data representative of the waveform are discrete values. By deriving a curve-approximated function using a parametric approximate method such as the linear least-squares method or robust least-squares method and a non-parametric such as interpolation or smoothing spline, the gradient of the waveform at t0 can be known. Otherwise, it can be simply acquired from two points subjected to circuit simulation in the vicinity of t0. That the waveform (W5 in FIG. 2) obtained by the circuit simulation on the basis of the circuit parameter updating information is approximate to the input value can be determined from the facts that the point (t0, V1) of the input data is near the waveform W5 in distance and the gradient of the waveform W5 is approximate to the gradient of the waveform W2 at t0. If a plurality of items of circuit parameter updating information are candidates through the above determination, of these candidates, selected is the candidate with the least circuit area calculated by the circuit parameter and least power consumption derived by the circuit simulation.

### Embodiment 2

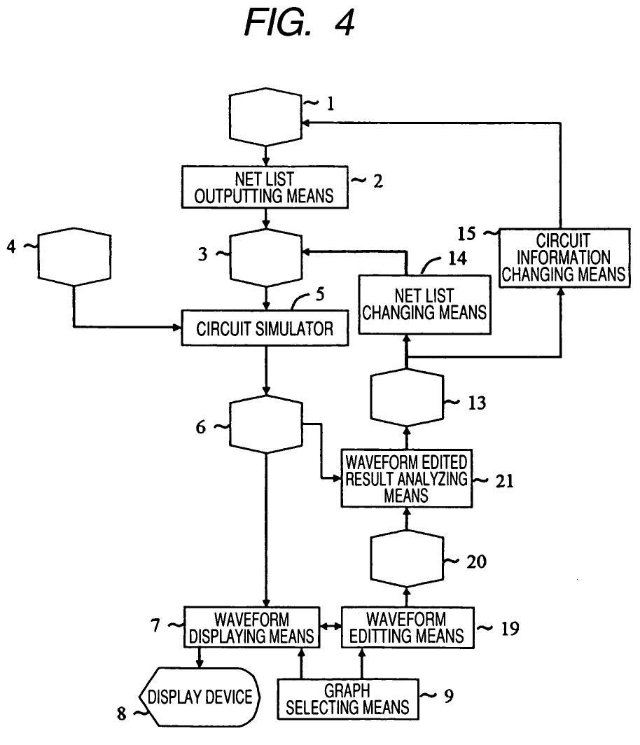

FIG. 4 is a block diagram showing the configuration of the second embodiment of this invention. This embodiment is characterized in that in the first embodiment, the voltage V was inputted as the information at a point by the inputting means 10, whereas in this embodiment, a waveform is inputted by a waveform editing means 19 and the waveform thus inputted is edited by a waveform edited result analyzing means 21. In this embodiment, since the waveform but not one point is edited, optimization is facilitated. Specifically, the mixed signal circuit simulator according to this embodiment includes, as seen from FIG. 4, a net list outputting means 2 for outputting net list data 3 from input data of circuit information data 1 holding information of a designed circuit; a circuit simulator 5 for creating waveform data 6 on the basis of the net list data 3 and input signal data 4; a waveform displaying means 7 for graphically displaying the waveform data 6 and a waveform selected by a graph selecting means 9 on a display device 8; a waveform editing means 19 for editing the waveform displayed on the display device 8 and outputting the result to waveform edited data 20; a waveform edited result analyzing means 21 for analyzing the waveform edited data 20 and the waveform data 6 to create circuit parameter updating information 13; a net list changing means 14 for changing the net list data on the basis of the circuit parameter updating information 13; and a circuit information data changing means 15 for changing the circuit information data 1 on the basis of the circuit parameter updating information 13.

The circuit information data 1 containing the information of the circuit created by the designer are processed by the net list outputting means 2, thereby producing the net list data containing circuit element information and connection information of circuit elements. By the net list data 3 and the input signal data 4 which describe an applying voltage and an applying current necessary for circuit simulation, a simulation condition, etc., the circuit simulator 5 is operated. Thus, actual circuit simulation is done so that an integrated circuit to be analyzed is analyzed. The circuit simulation result is outputted to the waveform data 6.

The waveform data 6 are inputted to the waveform displaying means 7. The waveform displaying means 7 graphs the waveform data 6, and the graph selected by the graph selecting means 9 is displayed on the display device such as a display. By means of the waveform editing means 19, for a part of the waveform of the graph selected, the designer executes the operation such as movement, enlargement, copying and replacement in a direction intended by the designer on the display device 8. The result is stored in the waveform edited data 20. The part where a curve has disappeared by the above operation is interpolated by the curve such as a spline; and in the part doubled on the X-axis or Y-axis, the waveform set by the designer is preferentially adopted and connected to the existing curve part by the curve such as the spline.

Further, any manipulating point can be provided on the curve by the manipulation by the designer The waveform can also be edited by manipulating the manipulating point. These manipulations can also be done by a pointing device such as a key board or mouse and its alternative device. By means of the waveform edited result analyzing means 21, the waveform edited data 20 and the waveform data 6 are analyzed to create the circuit parameter updating information 13. The net list changing means 14 changes the circuit parameter component of the net list data 3 using the circuit parameter updating information 13 and further operates the circuit simulator 5. The waveform data created by this operation is analyzed for comparison with the waveform by the designer through the waveform edited result analyzing means 21. If the error is within a permissible error, the circuit information data 1 are changed by the circuit information data changing means 15. However, if the error is not within the permissible error, new circuit updating information 13 different from that in the previous simulation is created and the net list data are updated. Such a series of operations are repeated.

This repetition is continued until the error stays within the permissible error and the circuit parameter updating information cannot be created any longer.

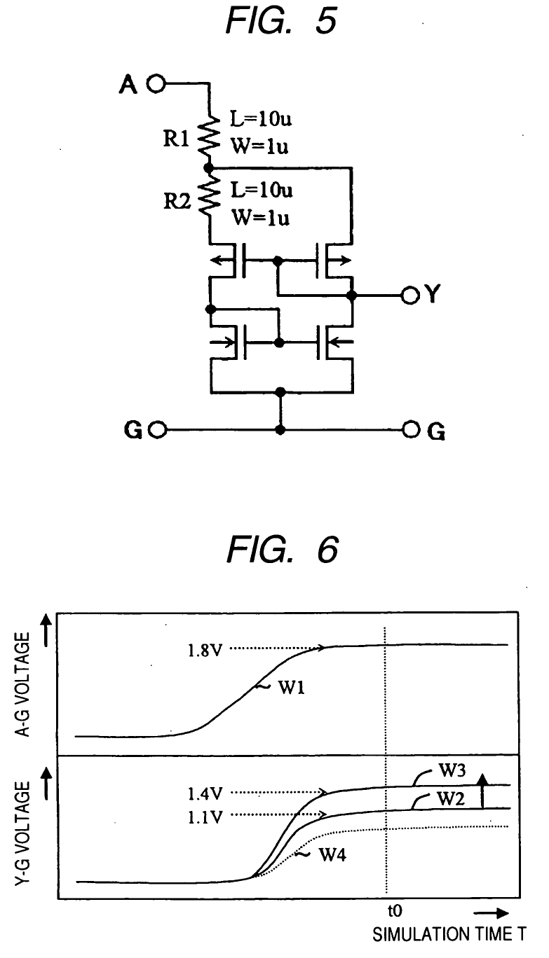

Now, the above series of operations will be explained referring to concrete examples. FIG. 5 is a constant voltage generating circuit which is generally well known.

In the circuit shown in FIG. 5, if a voltage is applied between terminals A and G the voltage which is very stable for power voltage fluctuation and process fluctuation is outputted between terminals Y and G For example, in this figure, it is assumed that where both resistors R1 and R2 commonly have a length of 10 μm and a width of 1 μm, the waveforms displayed on the display device by circuit simulation are as shown in FIG. 6. In FIG. 6, waveform W1 represents the voltage between the terminals A and G (hereinafter referred to as A-G voltage); and waveform W2 represents the voltage between the terminals Y and G (hereinafter referred to as Y-G voltage). In the present state, the waveform W1 gives 1.8 V at a simulation time t0 and the waveform W2 gives 1.1 V at the same simulation time. The waveform editing means can specify any interval or any point on the waveform on the graph taking X-axis of the simulation time and Y-axis of the A-G voltage, thereby modifying the waveform W2. By means of the waveform editing means, where the waveform of the Y-G voltage is modified from W2 into W3, i.e. is edited so as to give the voltage of 1.4 at the simulation time t0, the waveform edited result analyzing means temporarily analyzes the waveform edited data created by the waveform editing means.

Now, the circuit parameters of the circuit elements in FIG. 5 are subjected to multivariate analysis with the addition of a variable δ for each parameter. This analysis will be explained with reference to a simple and concrete example. Assuming that the width W of the resistor R2 in FIG. 5 is (1μ+0.1μ)m, the net list is updated by the net list changing means and the circuit simulator is operated. The waveform obtained by this circuit simulation gives the Y-G voltage of 1.05 V at the simulation time of t0 as indicated by W4 in FIG. 6. This value exhibits the direction opposite to the intended direction from 1.1 V to 1.4 V

Thus, it can be known that the variable δ added to the width W of the resistor R2 is δ<0. The further required thing is to recursively operate the waveform edited result analyzing means, net list changing means and circuit simulator, thereby calculating the variable δ sufficiently near the waveform edited data. The converging algorithm for this purpose may be the maximum gradient method (SD), conjugate gradient method (CG) or Newton-Raphson method (TN) which is known. In this example, since there is a single variable, for example, according to the serial bisecting tree method, assuming that the variable is δ1 having a sufficiently large absolute value and the circuit parameter on the resistor R2 is (1μ+δ1), if the Y-G voltage exceeds 1.4 V at the simulation time t0 on the waveform obtained by the circuit simulation, the circuit parameter δ capable of acquiring the waveform sufficiently approximate to the waveform edited data exists in a range of 0>δ>1.

Next, assuming that the circuit parameter is (1μ+δ1/2), the Y-G voltage at the simulation time t0 is acquired. If it exceeds 1.4 V, the circuit parameter to be acquired with exists within a range of 0>δ>δ1/2. In the case other than the above cases, the circuit parameter is within a range δ1/2>δ>δ1. Thereafter, likewise, by continuing bisecting of δ1, the circuit parameter capable of realizing the waveform edited data can be acquired.

The above technique is a simple example when there is a single variable. However, it is not difficult to extend this technique to multiple variables. For example, in the analysis in which there are two variables of L and W for R2, a solution can be obtained to give L=16 μm, W=0.5 μm and the Y-G voltage at simulation time t0 is 1.4 V In the analysis in which there are four variables of L and W for each of R1 and R2, a solution can be obtained to give L=6 μm and W=0.25 μm for R1 and L=14 μm and W=0.5 μm for R2.

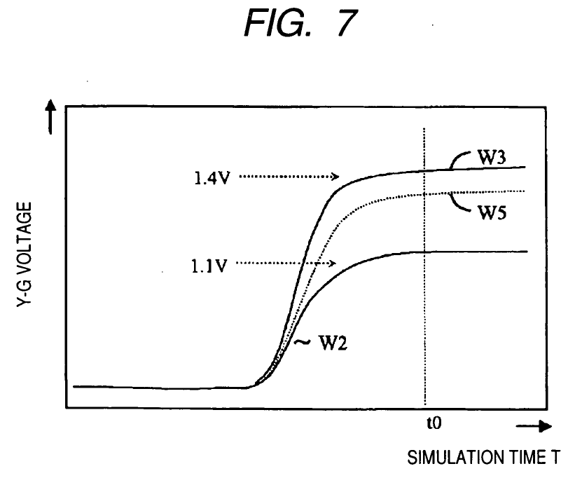

Further, as regards the above technique, referring to FIG. 7, an explanation will be given of agreement with the waveform data when the circuit simulation is executed on the basis of the waveform edited data and circuit parameter updating information. FIG. 7 is a graph when the graph of the Y-G voltage versus simulation time T in FIG. 6 is expanded vertically. In FIG. 7, waveforms W2 and W3 are the same as those in FIG. 6; and waveform W5 is the waveform when the circuit simulation is executed on the basis of the circuit parameter updating information. Generally, where the Y-G voltage is obtained as a function having a parameter t, i.e., the function representing waveform W3 is f(t) and the function representing waveform W5 is g(t), there is a technique of detecting the agreement by acquiring a mutual correlation function Rfg(t) and further calculating a mutual correlation coefficient. Further, where an actual covariant relationship is weak, it may be necessary to take a partial correlation coefficient.

However, as described above, since the waveform W2 and W5 are those obtained by circuit simulation, they provide discrete values. For this reason, the curve-approximated function described above may be derived and the correlation coefficient for the discrete data may be derived. It is effective that the waveform edited result analyzing means creates the circuit parameter updating information while giving priority to the correlation function with a large absolute value corresponding to each circuit parameter and brings the created information near to the edited waveform. As regards each of the waveforms, if there is a noise component owing to the external circuit not shown in FIG. 5, its influence can be suppressed by making the Fourier transform thereof and appropriately executing the low-pass, middle-pass or high-pass filtering. It is not known that the above operation is useful to improve the accuracy of detecting the agreement from the signal theory (Donald B. Percival, and Andrew T Walden. Spetral Analysis for Physical Applications: Multitaper and Conventional Univariate Techniques. Cambridge: Cambridge University Press, 1993).

The circuit parameter updating information thus obtained is reflected on the circuit information data. In this case, the values of the circuit information before and after changed may be confirmed on a circuit diagram editor and displayed as a changing list.

In this embodiment, the simulation time was set for X-axis whereas the terminal voltage was set for Y-axis. However, it is needless to say that for each of X-axis and Y-axis, the other physical magnitude such as a voltage, current or frequency can be set.

Further, where there are a plural sets of items of circuit parameter updating information, the semiconductor with less area and less power consumption can be designed by preferentially selecting the set with a least circuit area and least power consumption obtained the circuit simulation.

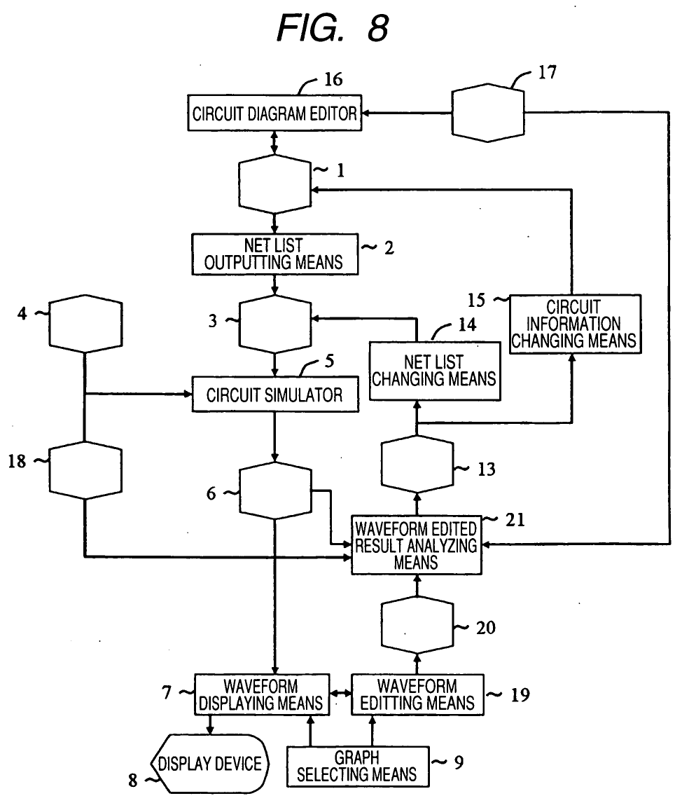

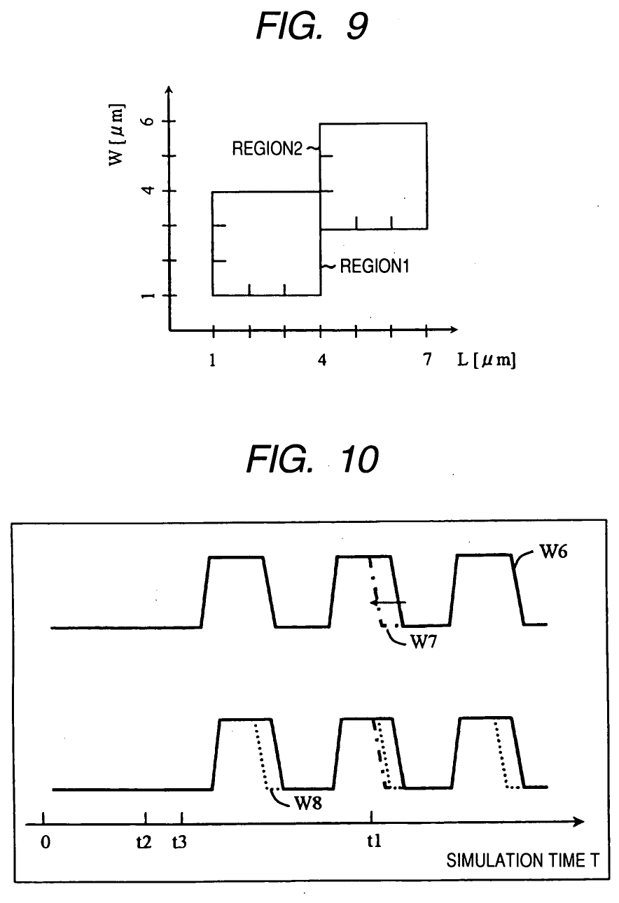

Now referring to FIG. 8, an explanation will be given of the mixed signal simulation. In FIG. 8, a circuit diagram editor 16, design rule definition data 17 and a device library 18 are added to FIG. 4. The design rule definition data contain physical limited information of each of elements employed in the circuit diagram editor. The physical limited information greatly depends on a manufacturing process such as the minimum size of the gate of a transistor elements, a minimum wiring width and a minimum size of via between the wrings, and further an increased width thereof, a minimum interval between elements, and maximum size of each element determined by the linearity and error range in extracting a device model. Referring to FIG. 9, the resistors explained in FIG. 5 will be explained. Both Land Ware represented by units of 1 μm step. The design rule definition data contain a resistor device model res_areal 1 where (L, W) is located within a range of region 1 represented by left lower point (1 μm, 1 μm) and right upper point (4 μm, 4 μm); and a resistor device model res_areal 2 where (L, W) is located within a range of region 2 represented by left lower point (4 μm, 3 μm) and right upper point (7 μm, 6 μ5m). These items of information will be employed in creating the layout or in outputting the net list data. Further, the device models res_area 1 and res_area 2 are stored in the device library.

In addition to the embodiment described above, by referring to the design rule definition data as an input to the waveform edited result analyzing means, the set of the circuit parameter updating information can be limited to discrete values and further the upper and lower limits of the circuit parameter can be set. In addition, since a suitable device model can be used, an unnecessary re-simulation time can be shortened and the circuit parameter which is driven by the design rule can be created.

Further, the device library stores the device model under the best condition and worst condition as well as a normal condition in terms of process and temperature. Therefore, by executing the circuit simulation under the best condition and worst condition after the circuit parameter updating information has been acquired under the normal condition, and by displaying, on the same display device, the waveforms under the above conditions which can be realized by the waveforms before and after edition and the updated circuit parameter, the designer can easily know the influence of the circuit parameter on the best condition and worst condition. Further, if the waveform analyzing means is adapted to edit the one waveform selected from the waveforms under the normal, best and worst conditions, in addition to using the waveform edited, the designer can make circuit design suitable to process fluctuation.

In addition to the above configuration, by adding, to the above design rule definition data, the information on the circuit element or circuit block inhibiting the change in the circuit parameter, and by preventing the circuit parameter corresponding to this information from being added to the circuit parameter updating information through the waveform edited result analyzing means, the circuit parameter is not be updated for e.g. a parasitic capacitance or parasitic resistance component. Therefore, the circuit parameter can be used in post-layout verification also.

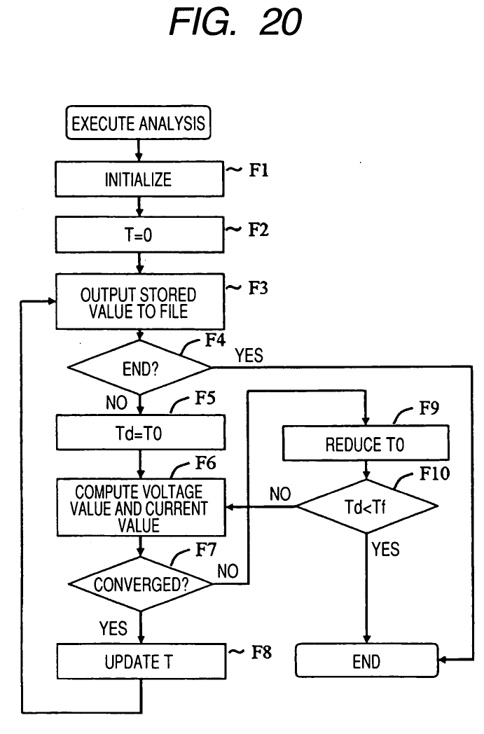

Next, an explanation will be given of the case where the circuit parameter updating information satisfying the waveform edited data cannot be obtained. In this case, the circuit design cannot be realized by within the circuit parameter range indicated by the design rule definition data. This corresponds to the case where the circuit simulator in FIG. 20 has been forcibly ended. Therefore, the circuit design cannot be realized by the existing circuit configuration. In this case, the input signal data are temporarily changed to determine if or not there is the circuit parameter satisfying the waveform edited data. In the above embodiment, with the input waveform being fixed, the circuit parameter satisfying the waveform edited data was acquired. Now, with the waveform edited data being fixed, the circuit parameter is subjected to the muitivariate analysis to acquire the circuit parameter most approximate to the input waveform. By displaying the input waveform thus obtained and the input signal data on the same display device, the designer can easily determine the validity of the input signal and necessity of changing the specification so that the period for designing can be shortened.

In the above embodiment, the above method was explained for the case only the single waveform is edited. However, this method can be applied to the case where a plurality of physical quantities of the same terminal or different terminals are simultaneously edited.

FIG. 10 shows the case where a periodic waveform is edited in this embodiment. In FIG. 10, waveform W6 indicates the waveform before edited and waveform W7 indicates the waveform after edited. In this case, the waveform edited result analyzing means can compute the periodicity of the waveform before edited, on the basis of the autocorrelation function. If the periodicity is recognized and the converged voltage and current at each node in the circuit simulation can be temporarily saved, the circuit simulation can be executed from partway without being executed from the simulation time t0. For example, in FIG. 10, if the converged voltage and current are temporarily saved in a file and the first period of the above periodicity is recognized from a simulation time t3, the re-simulation is executed from the simulation time t2, thereby acquiring waveform W8. Thus, the simulation time can be shortened.

### Embodiment 3

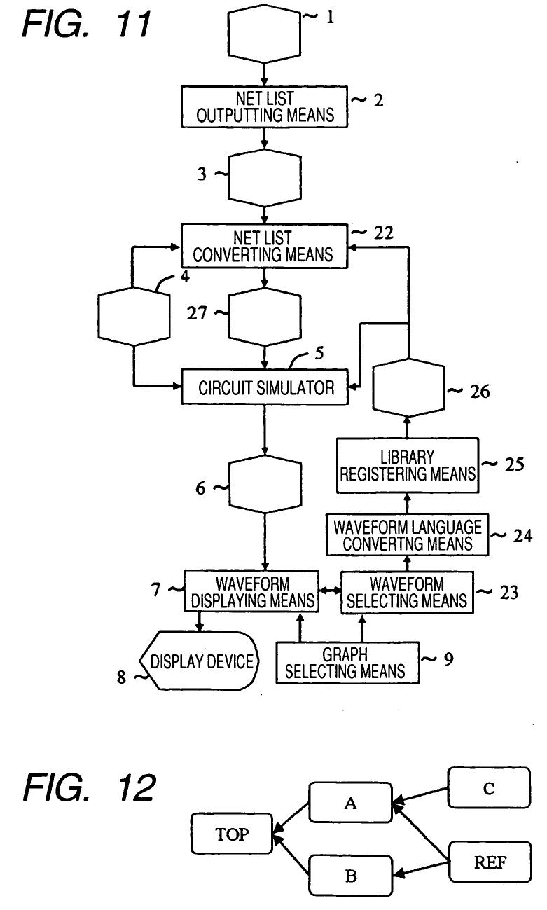

FIG. 11 is a block diagram showing the configuration of the third embodiment of this invention. This embodiment includes, as seen from FIG. 11, a net list outputting means 2 for outputting net list data 3 from circuit information data 1 of a created circuit diagram; a net list replacing means 22 for outputting net list replaced data from the net list data 3 using input signal data 4 and library data 26; a circuit simulator 5 for outputting waveform data 6 on the basis of the net list replaced data 27 and the input signal data 4; a waveform displaying means 7 for graphically displaying the waveform data 6 and a waveform selected by a graph selecting means 9 on a display device; a waveform displaying means 7 for displaying the waveform selected by the waveform data 6 on a predetermined display device 8; a waveform selecting means 23 for selecting the waveform displayed on the display device 8; a waveform language converting means 24 for converting the waveform selected by the waveform selecting means 23 into hardware description language; and a library registering means 25 for registering the hardware description language in the library data 26 through the waveform language converting means 24.

This embodiment is different from the first and second embodiments in that after the net list data 3 have been converted into the net list replaced data 27 using the input signal data 4 and the library data 26, the circuit simulation is executed; and there are provided the waveform language converting means 24 for converting the waveform selected by the waveform selecting means 23 into hardware description language and a library registering means 25 for registering, on the library data 26, the hardware description language created by the waveform language converting means 24 and the input signal data 4.

First, referring to FIG. 12, an explanation will be given of the hierarchical structure of circuit blocks. FIG. 12 shows the hierarchical structure having a circuit block TOP, circuit blocks A, B, and circuit blocks C, REF in the respective levels. Generally, the designer starts to create the lower level, i.e. circuit blocks C, REF, and finally creates the circuit block TOP. There is a connotation relationship between the respective levels. Specifically, the circuit block TOP incorporates the circuit blocks A and B; and the circuit block A incorporates the circuit blocks C and REF. Thus, the circuit blocks can be employed repeatedly so that the circuit design can be made effectively. The net list data can have also the same hierarchical structure as shown in FIG. 12. The net list data having this structure is referred to as hierarchical net list data. On the other hand, the net list data not having this structure is referred to as flat net list data. Further, the net list data component corresponding to the circuit block incorporated is referred to as a sub-circuit. A general circuit simulator can deal with the hierarchical net list data. Further, a mixed signal circuit simulator can employ, for each sub-circuit, not only SPICE but also hardware description language or system language such as VHDL or Verilog.

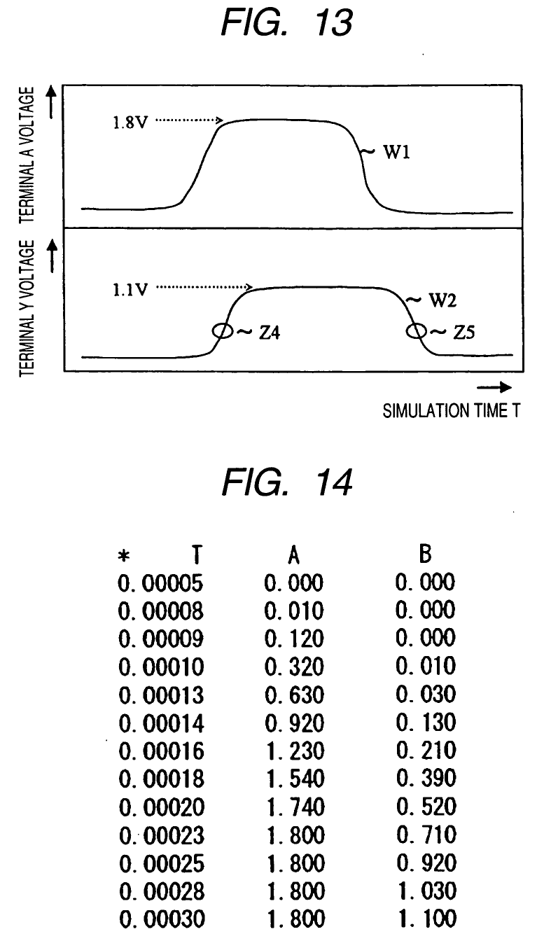

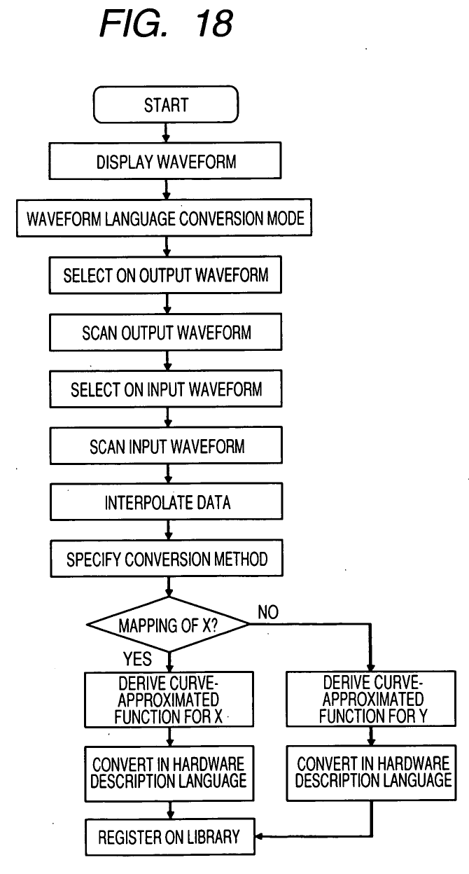

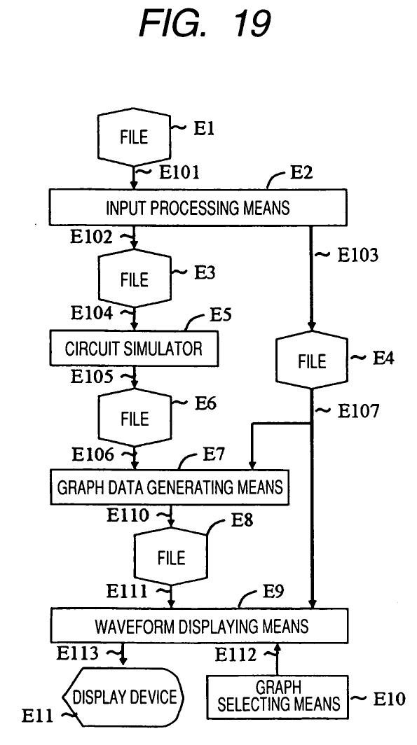

An explanation will be given of the registering method for the library 26. FIG. 13 shows the response waveform in the circuit in FIG. 5, taking the X-axis of the simulation time and Y-axis of the input terminal A voltage and output terminal B voltage (both grounded to terminal G). FIG. 18 is an execution flowchart to reach registering onto library data. Now, in a state where the voltage waveform W1 at the terminal A and the voltage waveform W2 at the terminal B are being displayed on the display device, point Z4 on the waveform W2 is selected in a specific mode using e.g. a pointing device. In response to this operation, the waveform selecting means 23 acquires sets of points represented by the simulation time and the terminal Y voltage on the waveform from the vicinity of point Z4 on the waveform W2 in directions of the maximum value and minimum value. The maximum value and minimum value of the waveform can be acquired by approximation of the above waveform. In this example, on the assumption of a monotonous increase and monotonous decrease, acquisition of the set of points will be continued until the voltages at adjacent points fall within a predetermined error. Next, the waveform selecting means 23 requires designation of the node to be dealt with as the input signal. Now, it is assumed that the terminal A is designated. Thus, the waveform selecting means 23 scan points in the vicinity of the simulation of point Z4 on the waveform W1 thereby to acquire the set of points represented by the simulation time and the terminal A voltage as in the case of the waveform W2. This operation is also continued until the voltages at adjacent points fall within the predetermined error. In this way, two kinds of sets of points can acquired. The excessive/insufficient quantity of voltage value between the two sets is removed or supplemented. The list of points thus acquired is shown in FIG. 14.

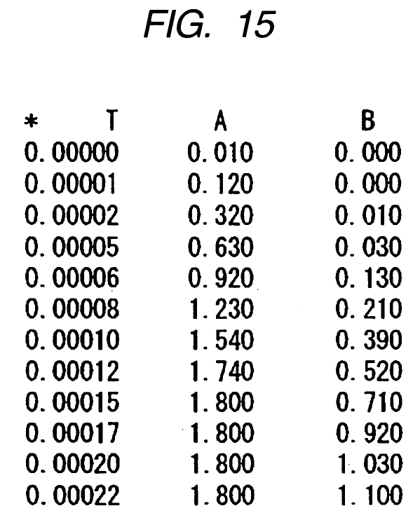

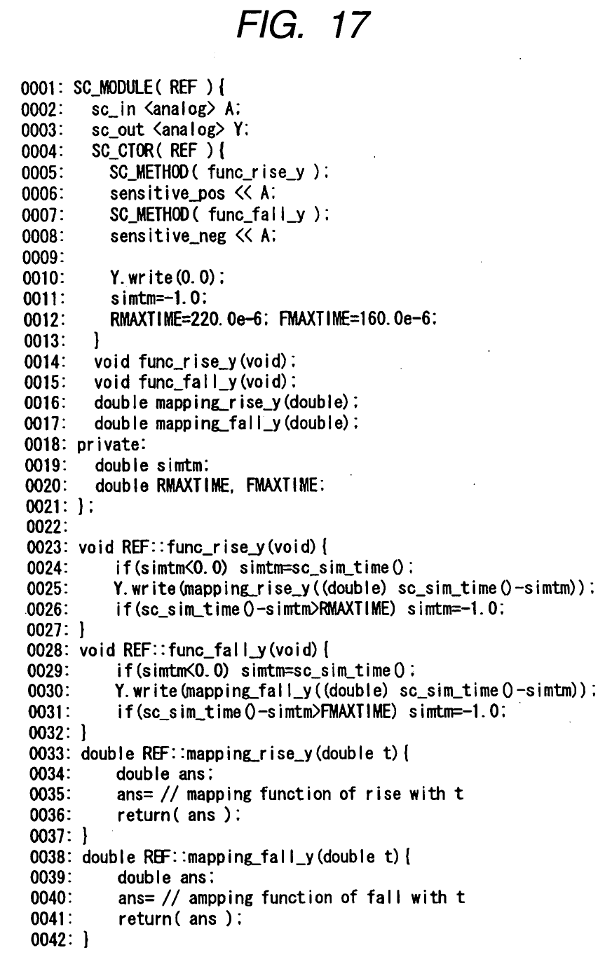

Next, the axes serving as an origin of mapping is designated. In this case, the X-axis representing the simulation time and the Y-axis representing the terminal A voltage can be designated. Now, it is assumed that the X-axis is designated. Thus, a series of data are created with the first voltage change at the terminal A being set at the simulation time T0. Namely, the list of FIG. 14 is converted into the list of FIG. 15. By curve-approximating the first and third rows on this list by the technique described above, the response function R(t) of the terminal Y is acquired with the simulation time on the rise side of the terminal A being a parameter. The same operation is also done for the fall side of the terminal A to acquire the response function F(t) of the terminal Y Subsequently, the waveform language converting means creates the hardware description language represented by FIG. 17. Now, the numeral and colon “:” from the top represent the corresponding row number. The 0002 row declares the terminal A, the 0003 row declares the terminal Y, and RMAXTIME in the 0012 row represents the maximum value at the first row in FIG. 15, i.e. the maximum value of the simulation time in the curve-approximated function on the rise side. FMAXTIME corresponds to the maximum value on the fall side. At the 0035 row, the response function R(t) acquired is embedded; and at the 0040 row, the response function F(t) acquired is embedded.

Finally, the library registering means registers the hardware description language, creating date and the input data 4 as the same group and identifies the group by a unique name correlated with a sub-circuit name.

The above explanation relates to the method for creating the hardware description language given as the mapping of the simulation time.

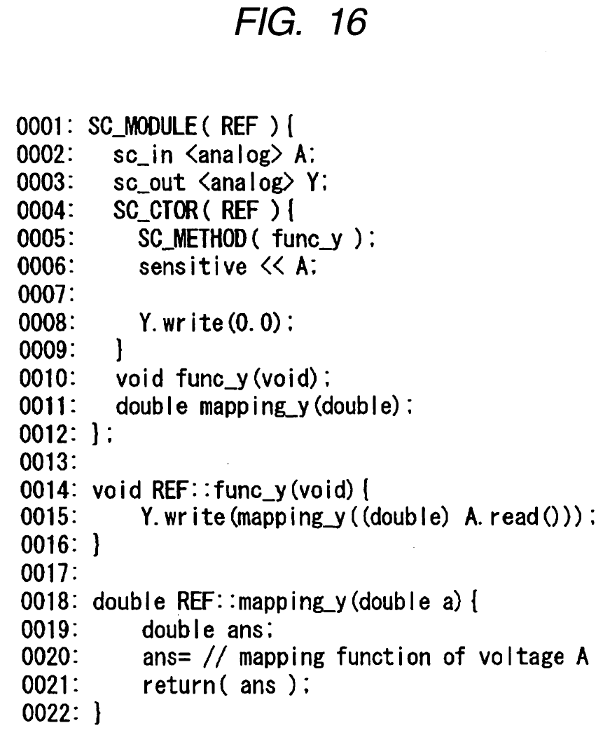

The above case is directed to the case where the waveform at the terminal Y has a delay from the waveform at the terminal A. However, as regards the terminal Y with no delay or equivalently expressed using the delay element outside the sub-circuit, it can be directly expressed as the mapping of the terminal A. For example, where the function of the waveform W1 is expressed as Va=I(t), if the waveform for the simulation time of the terminal Y is expressed by Vy=H(t), the waveform of the terminal Y relative to the terminal A can be expressed by a function H (I⁻¹(Va)). The library registered data in this case are shown in FIG. 6. In FIG. 16, in the 0020 row, the function acquired is embedded.

Further, by executing this operation under the best condition and worst condition, the library data with higher accuracy can be created, which can be used through replacement by the net list replacing means 22. As the case may be, by normalizing the list of FIG. 14 with a power source voltage, the library data can be used for the power source voltage in a wide range.

The library data thus created are replaced in units of the sub-circuit by the net list replacing means 22 in FIG. 11 in the next simulation. Thereafter, the circuit simulation will be executed. For the purpose of confirmation of compatibility, the net list replacing means asks the designer for the presence or absence of replacement about the cases (1) where the input signal 4 is different from that registered in the library and (2) there is circuit updating after the library registering in the hierarchical relationship including the pertinent circuit in the circuit information data 1. In this way, even when an abrupt voltage change at the terminal A, the circuit simulation can be executed in safety

In the embodiments described above, the waveform data were displayed on the display device 8. However, it is needless to say that the waveform displaying means including the display device is not necessary required, but the waveform data 6 may be corrected to give desired values by arithmetic processing.

This invention can be applied in designing the circuit using a mixed signal circuit simulator for not only a composite circuit of an analog circuit and a digital circuit but also for only the analog circuit.

What is claimed is:

1. A mixed signal simulator, comprising:
a net list outputting unit, outputting net list data from circuit information data of a circuit diagram created;
a circuit simulator, outputting waveform data on the basis of the net list data and input signal data;
an inputting unit, inputting data with a desired value; and
a waveform analyzer, analyzing the input data created by the inputting unit and the waveform data to create circuit parameter updating information.

2. The mixed signal circuit simulator according to claim 1, wherein the waveform analyzer selects a point on the waveform selected from the waveform data so that the input data and the waveform data are analyzed to create the circuit parameter updating information.

3. The mixed signal circuit simulator according to claim 1, wherein the waveform analyzer comprises:
a waveform editor, editing a waveform selected from the waveform data;
a waveform edited result analyzer, analyzing the waveform edited data created by the waveform editor to create the circuit parameter updating information.

4. The mixed signal circuit simulator according to claim 2, further comprising:
a net list changer, changing the net list data on the basis of the circuit parameter updating information; and
a circuit information changer, changing the circuit information data on the basis of the circuit parameter updating information.

5. The mixed signal circuit simulator according to claim 2, further comprising:
a waveform display, displaying a waveform selected from the waveform data on a predetermined display device, wherein the waveform analyzer executes analysis on the basis of the waveform displayed on the waveform display.

6. The mixed signal circuit simulator according to claim 4, wherein the circuit information changer changes the circuit information data into a fixed value relied on a design rule on the basis of the circuit parameter updating information.

7. The mixed signal circuit simulator according to claim 2, wherein if there are a plurality of items of circuit parameter updating information capable of making the waveform passing the vicinity of the input data created by the inputting unit or the waveform edited by the waveform editor, the circuit parameter updating information with the least circuit area or least circuit power consumption can be preferentially selected.

8. The mixed signal circuit simulator according to claim 5, wherein the waveform editor is adapted to display the waveform under a normal condition and the waveforms under the best and worst conditions; and
the inputting unit or waveform editor is accepted for a waveform selected from the waveforms, and according to the circuit parameter updating information, all the waveforms are taken as candidates for re-display or re-edition.

9. The mixed signal circuit simulator according to claim 5, wherein if there is no set of items of circuit parameter updating information created by the waveform analyzer or the waveform edited result analyzer, and the circuit parameter can exist by changing the input signal data, an emphasized pertinent part of the input signal data is displayed on the display device.

10. The mixed signal circuit simulator according to claim 5, wherein if a waveform portion inputted from the input data or edited from the waveform edited data is a part or entirety of the waveform repeated successively, a repetitive first simulation time in repetition is acquired from the waveform data, and in the circuit simulation after the net list has been changed by the net list changer, the circuit simulation is executed at the repetitive first simulation time or its previous simulation time.

11. The mixed signal circuit simulator according to claim 1, further comprising:
a net list replacing unit, outputting net list replaced data from net list data using the input signal data and library data.

12. The mixed signal circuit simulator according to claim 1, wherein the circuit simulator comprises:
a waveform display, displaying a waveform selected from the waveform data on a predetermined display device;
a waveform selector, selecting the waveform displayed on the display device;
a waveform language converter, converting the waveform selected by the waveform selector into a hardware description language; and
a library register, registering the hardware description language created by the waveform language converter on the library data.

13. The mixed signal circuit simulator according to claim 12, wherein an output signal relied on the hardware description language is given as mapping of an input signal.

14. The mixed signal circuit simulator according to claim 12, wherein an output signal relied on the hardware description language is given as mapping of a simulation time.

15. The mixed signal circuit simulator according to claim 14, wherein the output signal relied on the hardware description language is described for both rise and fall of the input signal.

16. The mixed signal circuit simulator according to claim 13, wherein the hardware description language under a normal condition and the hardware description languages under the best and worst conditions are registered and used through replacement by the net list replacing means.
